(19) United States
(12) Patent Application Publication
(10) Pub. No.: US 2018/0032722 A1
(43) Pub. Date: Feb. 1, 2018

(54) VISUAL ACCESS ALERT SYSTEM

(71) Applicant: Carneros Bay Capital, LLC, San Francisco, CA (US)

(72) Inventors: Mark CARLSON, Half Moon Bay, CA (US); Patrick STAN, Pacifica, CA (US)

(21) Appl. No.: 15/659,443

(22) Filed: Jul. 25, 2017

Related U.S. Application Data
(60) Provisional application No. 62/368,405, filed on Jul. 29, 2016.

(51) Int. Cl. G06F 21/55; H04L 29/06; G06F 21/44; H04L 29/08; G06F 21/31

(52) U.S. Cl. CPC G06F 21/552; H04L 67/26; G06F 21/31; G06F 21/44; H04L 63/101

(57) ABSTRACT

A user is involved in security on each access of a website, application or other computer element, and leveraging the user to enhance security. In one embodiment, a Post widget is placed on a website login page on the user's browser. The Post widget will record access activity and report the activity to a remote Access Alert server. Upon each subsequent access, a pop-up display will indicate to the user access history, such as recent successful or unsuccessful access activity.

### CROSS-REFERENCES TO RELATED APPLICATIONS

This application claims the benefit of U.S. Provisional Patent Application No. 62/368,405 filed Jul. 29, 2016, entitled “Visual Access Alert System”, the disclosure of which is hereby incorporated herein by reference in its entirety.

### BACKGROUND OF THE INVENTION

The present invention relates to the security of user accesses of websites, applications and other computer elements.

Existing systems require a user logon and password. Typically, attempts to access are monitored by a web server or other provider without user involvement. An email or other notice may be sent to the user reporting activity that has the potential to be disruptive or a suspect transaction, and may require a password reset, freezing an account, etc. However, the user is typically not otherwise involved.

### BRIEF SUMMARY OF THE INVENTION

The present invention relates to involving the user on each access of a website, application or other computer element, and leveraging the user to enhance security.

In one embodiment, a Post widget (application or code snippet) is placed on a website login page on the user's browser or the login of an application. The Post widget will record access activity and report the activity to a remote Access Alert server. Upon each subsequent access, a pop-up display (whisper) will indicate to the user access history, such as recent successful or unsuccessful access activity. The user can then determine whether the access activity was his/her own (authorized), or unauthorized. The pop-up display can be color coded to convey information, such as red to indicate a possibly unauthorized access and green to indicate an authorized access.

In one embodiment, a Post widget is also placed on the user device to log device activation and access (e.g., device turn-on password) activity. This access activity is reported to the remote Access Alert server. The Access Alert server can combine both device and website/application access information for an alert sent to the user upon access of the device and/or website/application.

In one embodiment, for a site or account that provides for transactional activity, the transactional activity is also monitored and included in the reported activity. The activity and accesses of any related products can also be monitored, such as off line activity and transactions, as well as online activity. The activity of other entities, companies or products related to the same user can also be combined and displayed when the user is on the site or application of any one of a group of entities serving the same user.

### BRIEF DESCRIPTION OF THE DRAWINGS

FIG. 1 is a diagram of an access alert system according to an embodiment.

FIG. 2 is a diagram of the data fields of a Post message according to an embodiment.

FIG. 3 is a diagram of an access alert format according to an embodiment.

FIG. 4 is a diagram of a website showing one embodiment of an initial pop-up or whisper for an access alert.

FIG. 5 is a diagram of a topology and components according to one embodiment.

FIG. 6 is a diagram of a computer or server for devices of the system of FIG. 1 according to an embodiment.

### DETAILED DESCRIPTION OF THE INVENTION

### Access Alert System

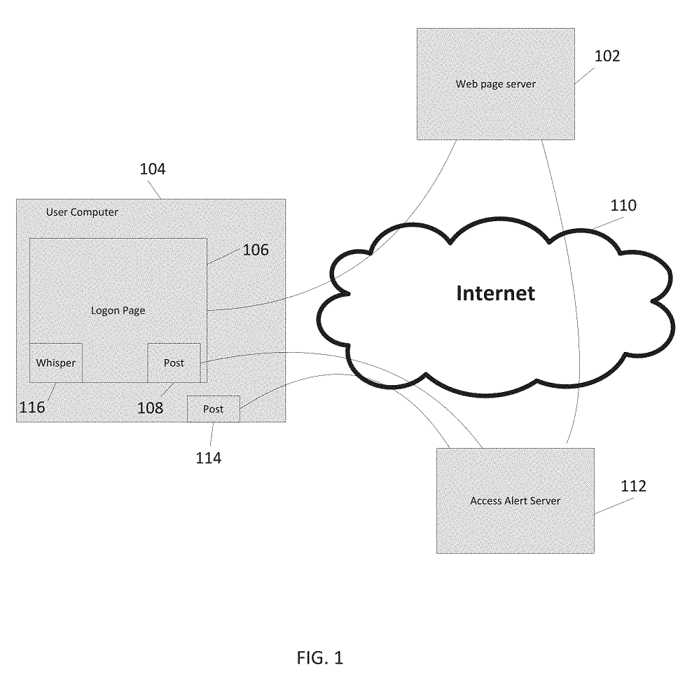

FIG. 1 is a diagram of an access alert system according to an embodiment. A website server 102 serves a logon page to a user computer 104. The user enters a user name and password to logon. With this information, the website server 102 generates a browser landing page 104 for that user. Website server 102 determines, based on the user name, whether the user has registered for an access alert service. If the user has registered, a Post widget 108 is included in the browser landing page 104 that is generated. The widget can be a short stand-along program or a code snippet added to an application. The Post widget will send a post message over the Internet 110 to an Access Alert server 112. The post message will include information identifying the device, user, application/website, etc., as well was whether the logon was successful or not, and other information as will be described below.

In an alternate embodiment, Post widget 108 is maintained at website server 102 for additional security. Post widget 108 will monitor the success or failure of user logon, and other information, from server 102 and send a post message to Access Alert server 112. The post message will identify the event, the application and the user.

Alternately, or in addition, the Post widget can be added to the original logon page before the user enters the user name and password. The website server can determine the device corresponds to a registered user based on the device ID detected when the user accesses the website. In another embodiment, the Post widget is provided to the browser of every device which accesses the logon page of the website, including unauthorized access attempts. The Post command sends a message to Access Alert server 112, which then tries to match the device information or user name to a registered user.

In one embodiment, a Post widget/code snippet 114 is added to the device itself. Post widget 114 will detect when the user activates the device, and when the user unlocks the device with a device password. A post message is then sent to Access Alert server 112. Access Alert server 112 can combine the device and website access information into one alert message which is sent to the user computer 104 for display as a pop-up notification or whisper 116.

In one embodiment, the post widget is added to an application downloaded to the user's device. The application itself may require a password to open or access certain information. Also, the application may require a password to access a remote server for more information, synchronization, etc. Such access attempts will be monitored and reported by the post widget.

In one embodiment, Access Alert server 112 monitors multiple websites or entities where the user is registered or has an account. When the user is on a website, or accessing an application, of any one of the sites or entities registered with the Access Alert server, a notification can be provided regarding activity for other entities or sites. For example, multiple login alerts could be confirmed by a user as having updated all his/her passwords, or could indicate identity theft. The whisper could include information on other sites or entities, or a separate whisper could be provided for other sites or entities. Information in the whisper for a website or application could also be sent to other entities, or could be sent upon user action indicating the reported access or other activity may be unauthorized, such as changing a password by the user in response to a whisper.

In one embodiment, additional features can be added to a whisper, such as recent transactions or other user activity. The whisper can simply indicate that there is such activity, such as with a number, and the user can click on the whisper for more details.

In one embodiment, rather than a post widget, the website or entity provides an API or other access to the Access Alert server. The Access Alert server is provided log-in records maintained by the website or entity. Alternately, the website or entity can have a widget or program loaded that monitors the logins of users registered with the Access Alert server program, and pushes the log-in data to the Access Alert server, or other server or computer for collecting the data.

### Post message

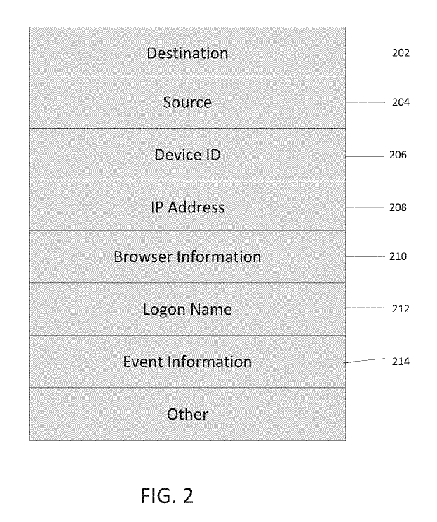

FIG. 2 is a diagram of one embodiment of a post message. Field 202 identifies the destination, the Access Alert Server. Field 204 identifies the source 204. The source can include information such as a device ID 206, IP address 208, browser information 210, etc. Detailed information about the browser version, device model, etc. can be obtained from the user device and included to uniquely identify the device. The login name 212 is included along with event information 214. The event information can be attempted logon, password reset, etc. The event information will include the time and date information as well.

With every attempted login, successful or unsuccessful, the authentication process will write a “log” record to an appropriate server. That record will contain sufficient information for the system to capture (and associate with a consumer) the information. The data is written to a database (optimized for performance), with a record being inserted into the database. The system will determine if an updated whisper should be sent to the owner's primary device. In one embodiment, different devices can be associated with a user. Each time a user successfully logs onto his/her account the system will compare the device's thumb print (i.e. hardware, browser (version), operating software/version, and cookies present, etc.). Subsequent logins by a user will compare the device that was used to login, against a history of logins by the consumer with the device's thumb print. If this is the first time the device has been used to access (e.g. Account “123”) then it is assumed that this is a new device. If a known device attempts to login (and that device is associated to a single/limited number of UIDs) and the UID entered is NOT on file, that is also captured. Code snippet 114 causes a SOAP or Restful call that formats the data, according to the API and sends the data to the appropriate end point. The application embeds the snippet at appropriate places in order to achieve this desired effect.

Event information can include the following:
Successful Logon
Known UID, bad password
Bad UID
Device Activated (by user, by OS, by . . . )
User Time Out
User Logoff
Request to reset PW Invalid User
Request to reset PW Valid User
Password Reset
Password reset other (email sent, . . . )
Forgot UID Request
UID changed
Application (or program ID)
Profile update.
Date and Time of the activity.
Activity/transaction online
Activity/transaction offline

In one embodiment, other types of access information can be monitored. For example, electronic or remote access to a physical door lock can be monitored. The user can be a business owner, and the monitoring can be of all employee devices provided by the owner. In one embodiment, the types of actions monitored and posted can be customized by the user or the website or application owner.

### Access Alert

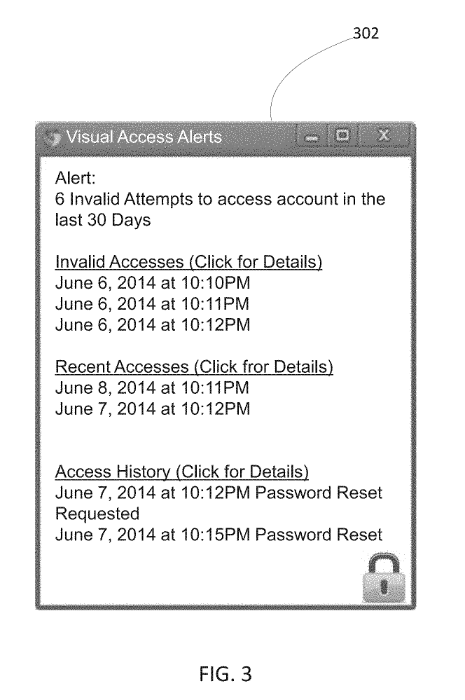

FIG. 3 is a diagram of an access alert 302 according to an embodiment. Access alert 302, in the example shown, shows the number of invalid access attempts in the last 30 days, and the times of the last 3. A user can click on “Click for Details” to find out more information, which can include all the data received in the post message, as described above. The example shown also provides the times of recent valid accesses, and an access history which provides such things as a password reset. The alert can include a variety of combinations of information, and can provide additional information upon clicking on a general “Other access information” (not shown). Some examples of information that can be provided include:
X Invalid Attempts in past 30 Days
X Days Since Last Password Reset
Last access from Different device
Recent Access from Suspect Device (a new device that has also recorded failures)
Recent Password Reset
Logout by user
Logout by timeout
Number of Unique Devices accessing account
Number of suspect devices accessing account
Number of “new” devices accessing account
Device total failed access
User IDs total failed

In one embodiment, the devices can be identified by associating a common name during a registration process, or a user can be prompted the first time the device ID appears in an alert. For example, common names can be Mark's phone, Mark's tablet, wife's phone, den computer, etc. This allows quick and easy recognition of whether an access is authorized or not.

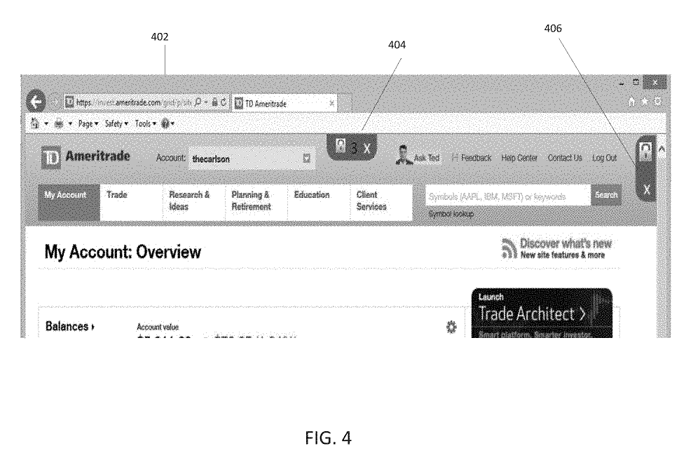

FIG. 4 is a diagram of a website 402 showing one embodiment of an initial pop-up or whisper 404. Whisper 404 can be color coded to convey information. For example, red can indicate unauthorized access and recommended action by the user (e.g., password change). In addition, red can indicate access by a new device, which requires user action to confirm whether it was an authorized device. Yellow can indicate recommended administrative action by the use, such as that it is time to change the password. Green can indicate that no problems are noted, and no action is required. As shown, a number (3 in FIG. 4) can indicate the number of access attempts within a recent period of time (e.g., the last 24 hours or last week). Additionally, or alternately, a sound can be produces with the pop-up, with a different sound for a possibly unauthorized access or other activity. Additionally, different haptic feedback could be used. In one embodiment, the user can set the time period, or it can be automatically adjusted based on usage. For example, if the user only accesses a site or application on average 3 times a week, the time period can be set to a week. If the user changes to accessing 4 times a day, the default can be automatically changed to the last 24 hours. The “x” allows the user to close the whisper. If the user wants more detail, the user can click the logo (a lock in FIG. 4) to get more information, such as the detail shown in FIG. 3. As shown above, the user can drill down even further for more information in the view of FIG. 3.

In one embodiment, if a red whisper is provided, the user can determine if the conditions that caused the red condition were OK (expected). To facilitate user review, the user is told if new actions/events caused the status to be moved to red again. Alternately, if it was red for valid reasons it can remain red for a period of time (e.g., the next 30 days), regardless of whether the user has indicated it is OK.

In one embodiment, depending upon the alert, various recommended actions can be presented to the user. For example, the user can be prompted to change a password, verify an account, or check recent activity or a bank balance. If the detected unauthorized access suggests a device may be compromised, an alert can be sent to another authorized and registered device associated with the user, or by other means (e.g., email, mobile text messages, IVR outbound calls, postal mail). A prompt to notify the website or application owner (e.g., the user's bank) can be provided.

In one embodiment, access alerts can provide other access related information, such as the last time an application or website was viewed or input provided, etc. This can be for actions subsequent to a logon (including profile updates, etc.), or for sites or applications that don't require a logon.

In one embodiment, a whisper 406 is used instead of whisper 404, on the side, instead of the top, and with less information. Any variety of placements, shapes and amounts of information can be used in various embodiments.

In one embodiment, a post is provided from every page for an access attempt, including unauthorized accesses. However, the access alerts are not sent to a device, web page or application where an unauthorized access is being attempted. Rather, the access alert will only be sent to a verified, registered user device.

In one embodiment, access alert summaries are sent to the web page server 102 of FIG. 1. The summaries can be limited to attempted unauthorized accesses. Because the access alert server 112 also has information on other websites and applications, information on unauthorized access attempts by the same device can be provided. This will enhance the available fraud protection data of the website owner beyond their own website. If the user consents, the summary can also include authorized accesses. Also, if the user agrees, the summary can include information related to accesses of other websites or applications by the same user. The summary can also include unauthorized device access attempts, or a change of password of the device, which might indicate the user's device has been stolen or compromised, in combination with other data.

### Topology and Components

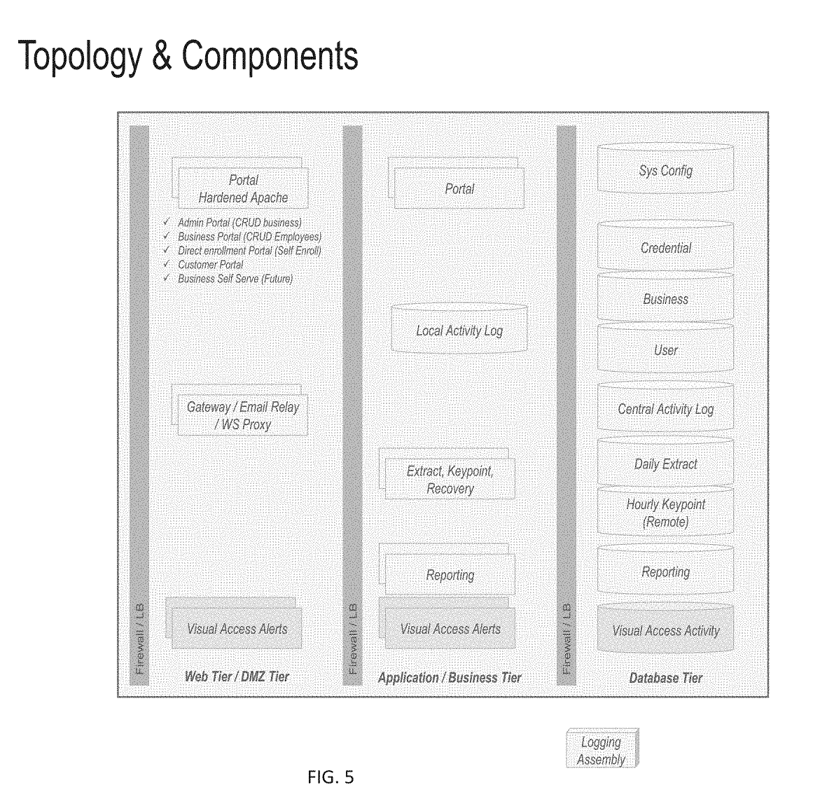

FIG. 5 is a diagram of a topology and components according to one embodiment. As shown, the access alerts can be tiered, or combined, across similar accessible elements. The Web Tier can monitor accesses to various websites. The Application/business tier can monitor accesses to applications downloaded to a device, or applications provided to employees by a business. A database tier can monitor just database access attempts. The posting of access attempts, and the sending of access alerts, can be segregated by type, or alternately could be combined but grouped into categories. The databases accesses could simply be monitored to record and show activity to the business, as opposed to sending alerts to end users. Alternately, a two tiered system can be used.

### Computer Diagram

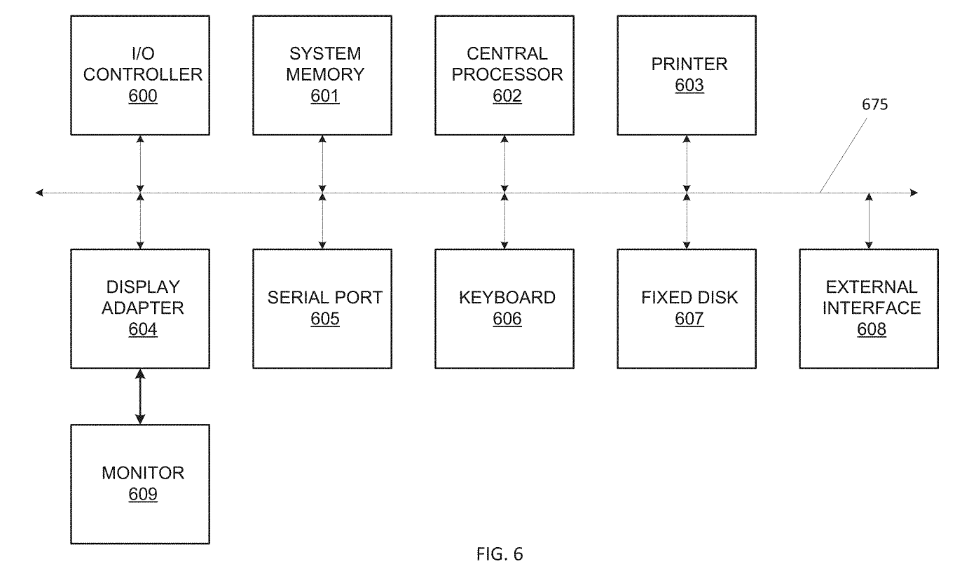

FIG. 6 is a high level block diagram of a computer system that may be used to implement any of the entities or components described above. The subsystems shown in FIG. 6 are interconnected via a system bus 675. Additional subsystems include a printer 603, keyboard 606, fixed disk 607, and monitor 609, which is coupled to display adapter 604. Peripherals and input/output (I/O) devices, which couple to I/O controller 600, can be connected to the computer system by any number of means known in the art, such as a serial port. For example, serial port 605 or external interface 608 can be used to connect the computer apparatus to a wide area network such as the Internet, a mouse input device, or a scanner. The interconnection via system bus 675 allows the central processor 602 to communicate with each subsystem and to control the execution of instructions from system memory 601 or the fixed disk 607, as well as the exchange of information between subsystems. The system memory 601 and/or the fixed disk may embody a computer-readable non-transitory medium.

As described, the inventive service may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

What is claimed is:

1. A method for notifying a user regarding access, comprising:
receiving access event reports from a user device;
logging the access event reports in a database; and
sending a past access report to the user device for display on the user device upon a subsequent user access.

2. The method of claim 1 wherein the past access report is displayed on the user device with different colors corresponding to whether a prior access or activity is determined to be possibly unauthorized.

3. The method of claim 1 wherein the past access report is displayed with a number of access attempts since one of a last access from the user device and a last access confirmed as authorized by the user and a last access displayed to the user and not flagged as unauthorized by the user.

4. The method of claim 1 wherein the access event reports include at least one of a device ID, IP address and browser information.

5. The method of claim 1 wherein the access event reports include at least one of a browser version and a device model.

6. The method of claim 1 wherein the access event reports include a login name and event information including at least one of an attempted logon and a password reset.

7. The method of claim 1 wherein the past access report include a user prompt to perform at least one of changing a password, verify an account and checking recent activity.

8. The method of claim 1 further comprising, when a detected unauthorized access suggests the user device may be compromised, sending an alert to another authorized and registered device associated with the user.

9. A method for notifying a user regarding access, comprising:
receiving access event reports from a user device;
logging the access event reports in a database; and
sending a past access report to the user device for display on the user device upon a subsequent user access;
wherein the past access report is displayed on the user device with different colors corresponding to whether a prior access or activity is determined to be possibly unauthorized;
wherein the past access report is displayed with a number of access attempts since one of a last access from the user device and a last access confirmed as authorized by the user and a last access displayed to the user and not flagged as unauthorized by the user;
wherein the access event reports include at least one of a device ID, IP address and browser information;
wherein the access event reports include at least one of a browser version and a device model;
wherein the access event reports include a login name and event information including at least one of an attempted logon and a password reset; and
wherein the past access report include a user prompt to perform at least one of changing a password, verify an account and checking recent activity.

10. An apparatus for notifying a user regarding access, comprising:
non-transitory computer readable media for providing access event reports from a user device;
a database;
a server in communication with the database and configured to log the access event reports in the database; and
non-transitory computer readable media for sending a past access report to the user device for display on the user device upon a subsequent user access.

11. The apparatus of claim 10 further comprising
non-transitory computer readable media on the user device configured to display the past access report on the user device with different colors corresponding to whether a prior access or activity is determined to be possibly unauthorized.

12. The apparatus of claim 10 further comprising
non-transitory computer readable media on the user device configured to display the past access report on the user device with a number of access attempts since one of a last access from the user device and a last access confirmed as authorized by the user and a last access displayed to the user and not flagged as unauthorized by the user.

13. The apparatus of claim 10 wherein the access event reports include at least one of a device ID, IP address and browser information.

14. The apparatus of claim 10 wherein the access event reports include at least one of a browser version and a device model.

15. The apparatus of claim 10 wherein the access event reports include a login name and event information including at least one of an attempted logon and a password reset.

16. The apparatus of claim 10 wherein the past access report include a user prompt to perform at least one of changing a password, verify an account and checking recent activity.

17. The apparatus of claim 10 further comprising:
non-transitory computer readable code for, when a detected unauthorized access suggests the user device may be compromised, sending an alert to another authorized and registered device associated with the user.
